(19) United States
(12) Patent Application Publication
(10) Pub. No.: US 2010/0265195 A1
(43) Pub. Date: Oct. 21, 2010

(54) PRESSURE SENSITIVE ADHESIVE SHEET AND DISPLAY DEVICE

(76) Inventor: Hisashi Watanabe, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/747,588

(22) PCT Filed: Aug. 8, 2008
(86) PCT No.: PCT/JP2008/064351

§ 371 Date: Jun. 11, 2010

(30) Foreign Application Priority Data
Dec. 14, 2007 (JP) 2007-323703

(51) Int. Cl. G06F 3/041

(52) U.S. Cl. 345/173

(57) ABSTRACT

The present invention provides a pressure sensitive adhesive sheet and a display device which can facilitate production of a display device having a front plate and reduce the thickness of such a display device. The present invention is a pressure-sensitive adhesive sheet that has a thickest portion with a largest thickness within a region corresponding to a display region of the image display unit, and has a thickness which continuously decreases from the thickest portion toward the end of the region.

### TECHNICAL FIELD

The present invention relates to a pressure sensitive adhesive sheet and a display device. More specifically, the present invention relates to a pressure sensitive adhesive sheet suitable as a member for attaching an image display unit and a front plate, and to a display device suitable as a display device that has an image display unit and a front plate attached to each other via the pressure sensitive adhesive sheet.

### BACKGROUND ART

A display device used for portable devices represented by recent cell phones has a protective plate arranged on the front face side of an image display unit such as a liquid crystal display in order to protect the display device from various shocks.

A material of such a protective plate needs to be highly transparent and resistant to shocks to be applied thereto, and is generally tempered glass, a resin plate made of a polycarbonate resin or an acrylic resin, or the like.

Many of those portable devices recently also have a touch panel as an input unit.

A touch panel detects the position of a contact object in contact therewith for example by measuring an electrical resistance changing according to pressure on the touch panel by the contact object. Such a touch panel is formed by arranging a light-transmissive substrate having a transparent electrode or the like formed thereon on the front face side of a display device or the like.

A material of such a touch panel also needs to be highly transparent and resistant to shocks to be applied thereto, and is generally tempered glass, a resin plate made of a polycarbonate resin or an acrylic resin, or the like.

Hereinafter, a protective plate arranged on the front face side of a display device, a light-transmissive substrate for a member such as a touch panel and the like each are also referred to as a front plate.

In conventional display devices provided with a front plate, the front plate is arranged on the front face side of an image display unit through an air space without being in close contact with the display surface of the image display unit.

This has sometimes led to light reflection in the interfaces between the front plate and the air space and between the display surface and the air space, considerably decreasing display qualities in bright environments such as particularly outdoors.

In view of this, investigations have been made to reduce the interface reflection and improve display qualities by arranging as a buffer layer a material with almost the same refractive index as that of the front plate and the image display unit, between the image display unit and the front plate, and thereby bringing the image display unit and the front plate into close contact with each other.

More specifically, Patent Document 1 for example discloses the method of attaching a protective panel or a light-emitting plate to a liquid crystal cell, with ultraviolet curable silicone gel provided as a buffer layer. This method includes a process of bringing the buffer layer into close contact with the protective panel or the light-emitting plate while deaerating, by curing a liquid feedstock of silicone gel poured on the protective panel or the light-emitting plate; and a process of bringing under the reduced pressure the protective panel or the light-emitting plate into close contact with the liquid crystal cell through the buffer layer.

Patent Document 2 discloses the method of attaching a liquid crystal display panel and a transparent protective plate through a shock-absorbing adhesive sheet and a volatile solvent interposed in the adhesive boundary.

Patent Document 3 discloses the method of sticking an image display device and a transparent protective plate through a light-transmissive pressure sensitive adhesive sheet made of a transparent gel, under a vacuum.

Patent Document 4 discloses the method of attaching a display panel and a protective plate having fine, rugged surface on the display panel side through a transparent layer made of resin; and the method of attaching a display panel and a protective plate, having a larger thickness in and/or near the center of a display panel side face than the thickness of surrounding parts, through a transparent layer made of resin.

### [Patent Document 1]

Japanese Kokai Publication No. H-6-337411

### [Patent Document 2]

Japanese Kokai Publication No. H-6-75210

### [Patent Document 3]

### Japanese Kokai Publication No. 2006-290960

### [Patent Document 4]

### Japanese Kokai Publication No. 2007-47621

### DISCLOSURE OF INVENTION

The techniques described in Patent Documents 1 to 3 require the processing of attaching the display device and the front plate through a buffer layer to be performed under a vacuum or reduced pressure so as to prevent inclusion of air bubbles. Further, this attachment process needs to be performed separately for each display device under a vacuum or a reduced pressure, which requires a longtime in the production. Accordingly, the techniques have room for improvement in terms of reduction of the time in the production.

Also, the techniques described in Patent Document 1 or 2 employ a liquefied solvent. This may require a process of wiping or washing the solvent in the attachment process if the solvent overflows from the edge of a display device or a front plate, which may further complicate the process and decrease the efficiency. These techniques therefore have room for improvement also in terms of simplification of the production process and improvement of the production efficiency.

The technique described in Patent Document 4 is costly because the front plate having a fine, rugged surface needs to be produced. Hence, the technique still can be changed in terms of reduction in production costs.

Further, in the case that the protective plate having a larger thickness in and/or near the center of the display panel side face than the thickness of the surrounding parts is attached to the display panel, the thickness of the transparent layer needs to be larger than the above thickness in and/or near the center of the display panel side face, according to the technique of Patent Document 4. This increases the thickness of the whole device. Accordingly, the technique can still be changed in terms of reduction in thickness of the whole device.

The present invention was made in view of the above-mentioned state of the art. The present invention aims to provide a pressure sensitive adhesive sheet and a display device which can facilitate production of a display device having a front plate and reduce the thickness of such a display device.

The present inventors have made various investigations on a pressure sensitive adhesive sheet and a display device which can facilitate production of a display device having a front plate and reduce the thickness of such a display device. As a result, the inventors have noted the thickness of a pressure sensitive adhesive sheet for sticking an image display unit and a front plate. The present inventors have found the following problem. Generally in the process of attaching an image display unit and a front plate, a pressure sensitive adhesive sheet is first attached to an image display unit or a front plate, and then one of the image display unit and the front plate, which has the pressure sensitive adhesive sheet attached thereto, is attached to the other of the image display unit and the front plate. Since a conventional pressure sensitive adhesive sheet is a plate-like sheet member having a substantially uniform thickness, attaching an image display unit and a front plate through a conventional pressure sensitive adhesive sheet by the above method causes air bubbles to be easily generated particularly between the pressure sensitive adhesive sheet and either of the members to which the sheet is attached later. Also, the present inventors have found an easy way to bring an image display unit into close contact with a front plate under a condition other than a vacuum or reduced pressure on condition that a pressure sensitive adhesive sheet has a thickest portion with a largest thickness within a region corresponding to a display region of the image display unit, and has a thickness which continuously decreases from the thickest portion toward ends of the region. This has led to an admirable solution to the above problem, whereby the present invention has been completed.

That is, the present invention is a pressure sensitive adhesive sheet for attaching an image display unit and a front plate, wherein the pressure sensitive adhesive sheet has a thickest portion with a largest thickness within a region corresponding to a display region of the image display unit, and has a thickness which continuously decreases from the thickest portion toward the end of the region.

The present invention is described in detail below.

The pressure sensitive adhesive sheet of the present invention is a sheet member for sticking an image display unit and a front plate, that is, a pressure sensitive adhesive sheet for attaching the image display unit and the front plate. Use of a sheet member makes it possible to attach an image display unit and a front plate while easily preventing an overflow of the sheet member from the edge of the image display unit or the front plate. This eliminates the process of wiping or washing the solvent which have been required in the case where a conventional liquid solvent is used. Accordingly, the pressure sensitive adhesive sheet of the present invention makes it possible to simplify production of a display device having a front plate and achieve high efficiency in the production.

The pressure sensitive adhesive sheet of the present invention has a thickest portion with a largest thickness within a region corresponding to a display region of the image display unit, and has a thickness which continuously decreases from the thickest portion toward ends of the region (the region corresponding to the display region of the image display unit).

With such a pressure sensitive adhesive sheet, an image display unit and a front plate can be attached through the following process. First, the pressure sensitive adhesive sheet of the present invention is attached to the image display unit or the front plate by a pressurizing unit such as a roller. Next, the thickest portion of the pressure sensitive adhesive sheet of the present invention, attached to one of the image display unit and the front plate, is put in contact with the other of the image display unit and the front plate. Then, the pressure sensitive adhesive sheet of the present invention is pressed against the image display unit or the front plate. This allows the sheet to be deformed and spreads the contact region (attachment region) between the sheet and either the image display unit or the front plate, from the thickest portion toward the surrounding parts while pushing out the air from the thickest portion toward the surrounding parts. Accordingly, the attachment process does not need to be performed under a vacuum or reduced pressure as in the conventional methods, and an image display unit and a front plate can be attached without inclusion of air bubbles, i.e., an image display unit and a front plate can be brought into close contact, even under atmospheric pressure, whereby production time of the display device having a front plate can be reduced.

The pressure sensitive adhesive sheet of the present invention is preferably soft and easily deformed by pressure. More specifically, the pressure sensitive adhesive sheet of the present invention preferably has a sufficient softness (hardness) to come into close contact with the image display unit or the front plate from the thickest portion toward the surrounding parts, that is, from the thickest portion toward ends of a region corresponding to the display region of the image display unit, when the image display unit or the front plate is pressed against the sheet. Further, the pressure sensitive adhesive sheet of the present invention is preferably deformed so as to come into close contact with the image display unit or the front plate at least in the region corresponding to the display region of the image display unit, when the image display unit or the front plate is pressed against the sheet.

The method of first attaching the pressure sensitive adhesive sheet of the present invention to either an image display unit or a front plate is preferably a method of attaching the pressure sensitive adhesive sheet of the present invention from an end thereof to the image display unit or the front plate by a pressurizing unit such as a roller. This method makes it possible to effectively suppress generation of air bubbles between the pressure sensitive adhesive sheet of the present invention and a member (image display unit or front plate) to which the sheet is to be first attached.

Further, a sheet member generally can be easily molded with a molding member such as a die. Hence, the cost for a display device provided with a front plate can be reduced, compared to a conventional case where the substrate of the front plate is processed.

Furthermore, the pressure sensitive adhesive sheet of the present invention has elasticity, and therefore can be attached to an image display unit or a front plate while being deformed, as described above. As a result, the pressure sensitive adhesive sheet of the present invention can have a substantially uniform thickness when arranged between an image display unit and a front plate, i.e., when an image display unit and a front plate are attached. Accordingly, the pressure sensitive adhesive sheet of the present invention allows reduction of the thickness of a whole display device provided with a front plate, even when compared to conventional techniques such as, for example, a technique described in Patent Document 4 in which the substrate of the front plate is processed.

Note that the region corresponding to the display region of the image display unit means a region corresponding to (overlapping) a display region of an image display unit in the state where the image display unit and the front plate are attached.

The above thickest portion may be a point (peak), may be a line such as a ridge line, or may be a region having an area within the range that does not allow generation of air bubbles of a visible size. In the case of being a region, the thickest portion is preferably a region of 10 μm or less in order to effectively prevent generation of air bubbles of a visible size. More specifically, in the case of having a dot shape, the thickest portion is preferably of a size that can be contained within a 10 μm square. In the case of having a line shape, the thickest portion preferably has a width (shorter side length) of 10 μm or less. As above, when the thickest portion is a region, the region may be of a dot shape or a line shape.

Also, “a thickness which continuously decreases” preferably means that the thickness decreases as if to give a convex shape. When the thickness decreases as if to give a convex shape, the shape of the pressure sensitive adhesive sheet of the present invention is not specifically limited to a shape having a curved surface, such as a shape of a so-called convex lens.

Pressure sensitive adhesion/sticking herein means temporarily attaching members to each other. The pressure sensitive adhesive sheet of the present invention preferably can be attached to an adherend by just being pressed with slight pressure, without a solvent, heat, or the like, and can be removed from the adherend without leaving a trace.

As above, the pressure sensitive adhesive sheet of the present invention preferably can removably attach an image display unit and a front plate. Accordingly, even when an image display unit and a front plate are not attached properly due to generation of air bubbles or the like in the production process, the pressure sensitive adhesive sheet of the present invention allows the image display unit or the front plate to be detached therefrom for a rework, i.e., allows reattachment of the image display unit or the front plate to the sheet. This leads to improvement in a yield rate of a display device having an image display unit and a front plate attached via the pressure sensitive adhesive sheet of the present invention. In contrast, attachment of an image display unit and a front plate via a high strength adhesive or the like, which disables a rework, has disadvantages in view of the yield rate, in that a failure in the attachment results in disposal of the attached members.

The thickness of the pressure sensitive adhesive sheet of the present invention is not specifically limited and can be set to a desired value. The thickness is preferably about 0.1 to 1 mm in a region corresponding to a display region of an image display unit when the image display unit and a front plate are attached. A thickness of more than 1 mm may cause a screen to be located on the back side, deteriorating the appearance. On the other hand, a thickness of less than 0.1 mm may allow shocks applied to a front plate to be easily transferred to an image display unit, thereby damaging an image display unit.

As above, the pressure sensitive adhesive sheet of the present invention is not necessarily a sheet member and may be a film member.

The size of the pressure sensitive adhesive sheet of the present invention is not specifically limited so long as the sheet can cover at least a display region of an image display unit when the unit is attached to a front plate. Accordingly, the size of the pressure sensitive adhesive sheet of the present invention alone may be about equal to or larger than the size of a region corresponding to a display region of an image display unit.

In the case that the size of the pressure sensitive adhesive sheet of the present invention is larger than that of a region corresponding to a display region of an image display unit, the thickness of parts outside the region is not specifically limited and may be appropriately set. Usually, the thickness is set to continuously decrease from the end of the region or to be uniform from the end of the region.

As above, the pressure sensitive adhesive sheet member of the present invention may be a pressure sensitive adhesive sheet having a thickest portion with a largest thickness and having a thickness which continuously decreases from the thickest portion toward the ends. Alternatively, the sheet member may be a pressure sensitive adhesive sheet having a thickest portion with a largest thickness and having a region in which the thickness continuously decreases from the thickest portion toward the surroundings.

Further, the thickness difference can be appropriately set between the thickest portion and a thinnest portion having the smallest thickness in the region corresponding to the display region of the image display unit. The thickness difference between the thickest portion and the thinnest portion is preferably within the range that the pressure sensitive adhesive sheet of the present invention comes into close contact with the image display unit or the front plate, from the thickest portion toward the ends of the region corresponding to the display region of the image display unit, as the image display unit or the front plate is pressed against the sheet. More specifically, the thickness difference between the thickest portion and the thinnest portion is preferably set such that the pressure sensitive adhesive sheet of the present invention has a thickness of about 0.1 to 1 mm within the region corresponding to the display region of the image display unit when the unit is attached to the front plate.

The structure of the pressure sensitive adhesive sheet of the present invention is not specifically limited, and may or may not include other components.

Preferable embodiments of the pressure sensitive adhesive sheet according to the present invention are described in detail below.

The thickest portion is preferably in the center of the region corresponding to the display region of the image display unit. This makes it possible to uniformly deform and spread the pressure sensitive adhesive sheet of the present invention even when the image display unit and the front plate each usually having a flat counter face are pressed against each other in parallel. Accordingly, entry of air bubbles between the pressure sensitive adhesive sheet of the present invention and the image display unit or the front plate can be more effectively suppressed.

Note that the center of the region corresponding to the display region of the image display unit does not need to be the exact center of the region as long as the location allows achievement of the above effect. For example, the location of the center of the region corresponding to the display region of the image display unit may be off the exact center of the region corresponding to the display region of the image display unit by a distance of about 1/10 of the diagonal length of the region corresponding to the display region of the image display unit. This can also lead to achievement of the same effect.

From the same point of view, the pressure sensitive adhesive sheet preferably provides contour lines each forming a circle at any height in a plan view. This makes it possible to uniformly deform and spread the pressure sensitive adhesive sheet of the present invention in all directions, further effectively suppressing entry of air bubbles between the sheet and the image display unit or the front plate.

Examples of a shape the contour line of which forms a circle at any height in a plan view include spheric shapes, aspheric shapes, and conical shapes. From the above point of view, the pressure sensitive adhesive sheet preferably has such a shape.

The pressure sensitive adhesive sheet preferably has a refractive index consistent with a refractive index of a member of each of the image display unit and the front plate, the member to be in contact with the pressure sensitive adhesive sheet. Such a structure allows effective suppression of light reflection conventionally generated in interfaces between the front plate and the air space, and between the display surface of the image display unit and the air space. This improves visibility of the display device in bright environments such as outdoors under brighter sunlight, and transmissivity of light emitted from a back light device. Hence, luminance of the display device can be improved and power consumption can be reduced.

A base (substrate) is preferable as the member, to be in contact with the pressure sensitive adhesive sheet, of each of the image display unit and the front plate.

Also, being consistent may mean being completely the same or being substantially the same, as long as the consistency is ensured within the range that allows achievement of the above effect.

The material of the pressure sensitive adhesive sheet is not specifically limited. A gel material (polymer gel material) is preferable and silicone gel is particularly preferable. That is, the pressure sensitive adhesive sheet preferably contains silicone gel. Silicone gel has high stress relaxation and high temperature resistance, and thus provides high morphological stability through temperature changes, when used for a pressure sensitive adhesive sheet. That is, even when exposed to temperature changes, silicone gel makes it possible to effectively prevent a substrate constituting each of the image display unit and the front plate from coming off, being distorted, or the like. Silicone gel also has excellent shock absorption, and therefore can effectively absorb shocks applied to the substrate constituting either of the image display unit and the front plate, and decreases the possibility that the shocks are transferred to the substrate constituting the other of the image display unit and the front plate. That is, silicone gel makes it possible to effectively prevent breakage of the substrate constituting either of the image display unit and the front plate due to shocks even in the case that the above substrate is vulnerable to shocks and shocks are applied to the substrate constituting the other of the image display unit and the front plate.

Examples of the gel material other than silicone gel include urethane gel and acrylic gel.

The pressure sensitive adhesive sheet preferably has one main face that is flat within the region corresponding to the display region of the image display unit. This allows more effective prevention of entry of air bubbles between the pressure sensitive adhesive sheet of the present invention and either of the image display unit and the front plate when the sheet is first attached to the image display unit or the front plate.

As above, the pressure sensitive adhesive sheet may have a convex shape (bulge) on one main face at the thickest portion.

The above various embodiments of the pressure sensitive adhesive sheet of the present invention described above may be suitably combined.

The present invention is also a display device including the image display unit and the front plate that are attached via the pressure sensitive adhesive sheet of the present invention. This easily provides a display device having an image display unit and a front plate in close contact via the pressure sensitive adhesive sheet of the present invention. Thereby, a display device achieving excellent visibility, excellent temperature resistance, and excellent shock resistance can be easily produced.

As above, the display device of the present invention may be a display device including an image display unit and a front plate that are in close contact via the pressure sensitive adhesive sheet of the present invention.

Note that “being in close contact” herein refers to the state in which an image display unit and a front plate are stuck in the range not causing adverse effects on display. Here, air does not need to be completely excluded from between the image display unit and the front plate, and air bubbles of an invisible size (more specifically, a size of 10 μm or less, and more in detail, a size that can be contained in a 10 μm square when air bubbles have a dot shape) may exist between the image display unit and the front plate.

The structure of the display device of the present invention is not specifically limited as long as the display device has the above components, and may or may not include other components.

Preferable embodiments of the display device according to the present invention are described in detail below.

The front plate is not specifically limited as long as it can cover a display surface (display region) of an image display unit. The front plate is preferably a protective plate or a touch panel, and particularly preferably a touch panel. That is, the front plate preferably has a touch panel function. In this case, the display device of the present invention can have a touch panel function while the image display unit can be protected from excessive shocks. Further, particularly in this case, the image display unit preferably does not physically change when the touch panel is pressed for input. Also in the case that the front plate is a protective plate not having a touch panel function, the image display unit preferably does not physically change when shocks are applied to the protective plate or the protective plate is pressed.

Note that a “touch panel function” is a function which enables access to various features upon just a touch on the display screen with a contact object such as a pen or a finger.

The above display device preferably further includes an adhesive or pressure sensitive adhesive member different from the pressure sensitive adhesive sheet, the adhesive or pressure sensitive adhesive member cooperating with the pressure sensitive adhesive sheet to attach the image display unit and the front plate. The pressure sensitive adhesive sheet of the present invention may change its shape with time to restore the original shape. At this time, the image display unit and the front plate may possibly come off the pressure sensitive adhesive sheet of the present invention upon the restoration of the original shape. Further attachment of the image display unit and the front plate via the adhesive or pressure sensitive adhesive member different from the pressure sensitive adhesive sheet of the present invention makes it possible to prevent restoration of the original shape of the sheet, effectively preventing coming off of the sheet from the image display unit and the front plate.

The arrangement place of the adhesive or pressure sensitive adhesive member is not specifically limited as long as the place is in a region that does not affect display. The adhesive or pressure sensitive adhesive member is preferably in a non-display region between the image display unit and the front plate. Thereby, coming off of the image display unit and the front plate from the sheet can be more effectively prevented, without causing of effects on display.

From such a viewpoint, the adhesive or pressure sensitive adhesive member may be in a non-display region on inner surfaces of the image display unit and the front plate.

The adhesive or pressure sensitive adhesive member is not specifically limited, and a pressure sensitive adhesive sheet or an adhesive sheet is preferable.

The adhesive sheet may be an adhesive tape.

The term adhesion herein, when used alone, preferably means permanently attaching members, and more specifically, bonding members by a chemical force, a physical force, or a combination of those forces. Accordingly, as the adhesive or pressure sensitive adhesive member, a pressure sensitive adhesive member (preferably pressure sensitive adhesive sheet) is more preferable in terms of an easy rework, and an adhesive member (preferably adhesive sheet) is more preferable in terms of more effective prevention of the image display unit and the front plate from coming off the pressure sensitive adhesive sheet of the present invention.

The image display unit (image display medium) is not specifically limited as long as it can have a front plate arranged thereon. The image display unit is preferably a display device workable in bright environments such as outdoors, and particularly preferably a liquid crystal display device. Use of a liquid crystal display device as the image display unit can lead to a display device that provides good display.

The liquid crystal display device preferably has a reflective display electrode provided in at least a part of an effective display region (pixel aperture region). The display device of the present invention allows effective suppression of light reflection conventionally generated in interfaces between the front plate and the air space, and between the display surface of the display device and the air space. The above embodiments therefore can provide a reflective or transflective (reflective-transmissive) liquid crystal display suitable for outdoor use, and provide high-contrast display.

The various embodiments of the display device of the present invention described above may be suitably combined.

### EFFECT OF THE INVENTION

The pressure sensitive adhesive sheet and the display device of the present invention can facilitate production of a display device provided with a front plate, and can reduce the thickness of such a display device. More specifically, a conventionally complex process of attaching an image display unit and a front plate can be performed easily and highly efficiently, and good display less susceptible to sunlight can be provided. Further, the thickness of the display device can be reduced, and display devices suitable for portable devices can be provided at high mass production rate.

### BEST MODES FOR CARRYING OUT THE INVENTION

The present invention is further described in detail based on the following Examples with reference to the drawings. The present invention is not limited to those Examples.

### Example 1

FIG. 7 are schematic views illustrating a display device of Example 1 according to the present invention: FIG. 7(a) is a cross-sectional view; and FIG. 7(b) is a plan view. FIG. 1 are schematic views illustrating the display device of Example 1 according to the present invention before attachment of a front plate and an image display unit: FIG. 1(a) is an exploded view seen from the cross section; and FIG. 1(b) is a plan view. The thick dashed lines in FIG. 7(b) and FIG. 1(b) indicate a display region, and the thin dashed lines giving a circular shape in FIG. 1(b) indicate contour lines of a pressure sensitive adhesive sheet.

The display device of the present Example has a structure where an image display unit 1 and a protective plate 2, provided on a display surface (front) side of the image display unit 1, are attached via a pressure sensitive adhesive sheet 3, as illustrated in FIG. 7.

The image display unit 1 is a common liquid crystal display device which is produced in the following way. First, a liquid crystal display panel is prepared in which a glass substrate having a transparent electrode formed in a matrix form thereon and a glass substrate having a transparent electrode continuously formed thereon are attached with a predetermined space therebetween such that the transparent electrodes of the respective substrates face each other and liquid crystals can be injected between the substrates. Next, a polarizer is attached to each face of the liquid crystal display panel, and then a back light device serving as a light source is arranged on the back side of the liquid crystal display panel.

The image display unit 1 is not specifically limited, and may be a display device other than a liquid crystal display device, such as an organic electroluminescence display device, an electrophoretic display device, or the like.

The protective plate 2 made of a material that is at least light transmissive and resistant to shocks to be applied thereto. The material is generally tempered glass, a resin plate made of a polycarbonate resin or an acrylic resin, or the like. In the present Example, a transparent acrylic plate having a thickness of 1 mm was used as the protective plate 2.

The pressure sensitive adhesive sheet 3 is a pressure sensitive adhesive sheet member having the largest thickness, i.e., a peak (thickest portion) 8 in the center, and having a convex shape. That is, the thickness of the pressure sensitive adhesive sheet 3 decreases gradually from the peak 8 toward the surroundings. In the present Example, the pressure sensitive adhesive sheet 3 was a sheet member having a rectangular shape in a plan view and having a size that covers at least a display region 9 of the image display unit 1. This sheet member was flat on the main face on the protective plate 2 side, had the peak 8 in the center of the display region 9, and had a thickness that allows contour lines 10 in a plan view to form a circle at any height.

The pressure sensitive adhesive sheet 3 is made of a material that is soft and easily deformable at normal temperature, such as, for example, a gel sheet. More specifically, a sheet made of a gel material containing silicone as a main material (silicone gel), for example, is preferable.

The softness of the pressure sensitive adhesive sheet 3 can be appropriately set. More specifically, penetration of the pressure sensitive adhesive sheet 3 is preferably 30 or more, and more preferably 50 or more. Such a value enables the pressure sensitive adhesive sheet 3 to be more easily deformed by pressure.

Note that the penetration can be determined, for example, by measuring a penetration length upon application of a load of 100 g to a steel standard needle at 25° C. for five seconds, and then representing 0.1 mm of the penetration length as 1.

The silicone gel is divided into a one part type and a two part type. The one part type is cured to a gel when heat or photoirradiation such as ultraviolet rays is applied. The two part type has two parts and the parts are cured to a gel when mixed at normal temperature or high temperature. Both types are in a liquid state before curing, and in a gel state after curing. A silicone gel of either of the one part type and the two part type can be suitably used as the material of the pressure sensitive adhesive sheet 3.

The refractive index of the sheet made of silicone gel is about 1.5, which is almost the same as the refractive index of the glass substrate constituting the image display unit 1, and as the acrylic plate serving as the protective plate 2.

The material of the pressure sensitive adhesive sheet 3 is preferably a material giving a clear, colorless cured product that has pressure sensitive adhesion. Use of a highly transparent material as the pressure sensitive adhesive sheet 3 makes it possible to improve display qualities of the display device of the present Example.

The transparency of the pressure sensitive adhesive sheet 3 can be appropriately set. More specifically, the pressure sensitive adhesive sheet 3 preferably has a light transmittance, according to JIS K7105, of 90% or higher, and preferably has a haze (cloudiness), according to JIS K7105, of 5% or lower. Such values enable effective suppression of a decrease in display qualities of the display device of the present Example.

The pressure sensitive adhesion of the pressure sensitive adhesive sheet 3 can be appropriately set to a desired degree of pressure sensitive adhesion.

Examples of a commercially available silicone gel product include Alpha GEL (produced by Geltec Co., Ltd.), SE1880 (one part type, produced by Dow Corning Toray Co., Ltd.), SE1886 (two part type, produced by Dow Corning Toray Co., Ltd.), IVS5022 (two part type, produced by Momentive Performance Materials Inc.) 1230H (two part type, produced by ThreeBond Co., Ltd.), and 1238 (one part type, produced by ThreeBond Co., Ltd.).

Examples of the gel other than silicone gel include urethane gel and acrylic gel. Here, examples of a commercially available urethane gel product include Gel tack sheets (produced by Exseal Corporation, Ltd.), and examples of a commercially available acrylic gel product include Maycleangel (produced by Kyodo Giken Chemical Co., Ltd.).

The pressure sensitive adhesive sheet 3 having a convex shape can be easily formed, for example, by a method of injecting a liquid (before curing) silicone material into a concave-shaped die; a method of pressing a concave-shaped die against a cured silicone material formed into a plate shape; or like methods.

The pressure sensitive adhesive sheet 3 was controlled to have a bowl shape with a thickness of 1 mm at the thickest portion and a thickness of 0.5 mm at the thinnest portion.

The pressure sensitive adhesive sheet 3 preferably has a thickness of about 0.1 to 1 mm after attachment, i.e., in a state of being sandwiched between the image display unit 1 and the protective plate 2.

The pressure sensitive adhesive sheet 3 produced thereby was attached by a roller or the like to a face on the image display unit 1 side of the protective plate 2 such that inclusion of air bubbles would be prevented.

Note that a removable film is preferably attached to each side, namely the surface (exposed surface) of the pressure sensitive adhesive sheet 3 and the surface (exposed surface) of the protective plate 2, of the protective plate 2 with the pressure sensitive adhesive sheet 3 attached thereto. This prevents dust from adhering to the protective plate 2 and the pressure sensitive adhesive sheet 3 during storage.

An attachment process of the protective plate 2 with the pressure sensitive adhesive sheet 3 attached thereto and the image display unit 1 is described below. FIGS. 2(a) to 2(c) are cross-sectional views illustrating the display device of Example 1 according to the present invention in the attachment process.

First, as illustrated in FIG. 2 (a), the non-attachment side of the image display unit 1 was vacuum-fixed on a plate stage 4 having a vacuum fixation function. Then, the face without the pressure sensitive adhesive sheet 3 attached thereto of the protective plate 2 was vacuum-fixed on a plate stage 5 which is placed to face the plate stage 4 and has a vacuum fixation function.

The plate stages 4 and 5 were arranged such that opposite faces were parallel to each other. If a removable film is attached on the surface of the pressure sensitive adhesive sheet 3, the film is detached here.

Next, as illustrated in FIG. 2(b), the plate stages 4 and 5, kept in parallel, were brought closer to each other, so that the convex portion (thickest portion) of the pressure sensitive adhesive sheet 3 came in contact with the surface of the image display unit 1.

As illustrated in FIG. 2 (c), the plate stages 4 and 5 were further brought closer to each other, and the image display unit 1 and the protective plate 2 were attached while the pressure sensitive adhesive sheet 3 was deformed. Thereafter, the vacuum fixation function was deactivated to release a display device having the image display unit 1 and the protective plate 2 attached therein from the plate stages 4 and 5, whereby the attachment process was completed.

The display device with the protective plate according to the present Example produced thereby had an average thickness of the pressure sensitive adhesive sheet 3 (buffer layer) of about 0.6 mm, which required only a small increase in the thickness of the display device as a whole.

Adjusting the thickness of the convex portion of the pressure sensitive adhesive sheet 3 to a smaller value before attachment may allow a further decrease in the thickness of the whole display device through the processes described above.

The pressure sensitive adhesive sheet 3 had a refractive index consistent with the refractive index of the glass substrate constituting the image display unit 1 and the acrylic plate serving as the protective plate 2. Accordingly, there was no light reflection in the interfaces between the protective plate 2 and the pressure sensitive adhesive sheet 3, and between the display surface of the image display unit 1 and the pressure sensitive adhesive sheet 3, which led to high visibility even under strong sunlight in the outdoors. Further, the light emitted from the back light device did not reflect in the interfaces, and thus screen brightness could also be increased.

FIG. 3 are schematic views illustrating a variation of the display device of Example 1 according to the present invention: FIG. 3(a) is a cross-sectional view; and FIG. 3(b) is a plan view. Note that the protective plate 2 is not illustrated in FIG. 3(b) FIG. 4 is a cross-sectional view schematically illustrating another variation of the display device of Example 1 according to the present invention. A low pressure sensitive adhesion of the pressure sensitive adhesive sheet 3 may possibly lead, to restoration of the convex shape of the pressure sensitive adhesive sheet 3 over time, detaching the image display unit 1 and the protective plate 2. In such a case, the following processes may be performed. That is, as illustrated in FIG. 4, the image display unit 1 and the protective plate 2 may be attached first, and then an adhesive member 6 may be attached over the image display unit 1 so that the image display unit 1 and the protective plate 2 are attached with the adhesive member 6. Alternatively, as illustrated in FIG. 3, an annular pressure sensitive adhesive member 7 may be first attached in a non-display region (a region outside the display region) which does not adversely affect display of the display device, and then the image display unit 1 and the protective plate 2 may be attached.

These processes make it possible to effectively prevent detachment of the image display unit 1 and the protective plate 2 due to restoration of the original shape of the pressure sensitive adhesive sheet 3.

In view of an easy rework, the pressure sensitive adhesive member 7 (for example, a pressure sensitive adhesive sheet made of the above gel material) is preferably used. In view of firmer fixation of the image display unit 1 and the protective plate 2, the adhesive member 6 (for example, an adhesive tape such as double-coated adhesive tape produced by Nitto Denko Corporation) is preferably used. The adhesive member 6 may be a pressure sensitive adhesive member, and the pressure sensitive adhesive member 7 may be an adhesive member.

FIG. 5 are schematic views illustrating a variation of the display device of Example 1 according to the present invention: FIG. 5(a) is an exploded view from the cross section; and FIG. 5(b) is a plan view. In FIG. 5(b), the thin dashed lines giving a circular shape indicate contour lines of the pressure sensitive adhesive sheet, and the thick dashed lines indicate the display region. The shape of the pressure sensitive adhesive sheet 3 is not specifically limited as long as it has different thicknesses within the face and allows attachment of the image display unit 1 and the protective plate 2 while pushing out the air. For example, the shape may be a conical shape illustrated in FIG. 5, a quadrangular shape, a semicylindrical shape, a triangle shape, or the like. As above, the pressure sensitive adhesive sheet 3 may have a curved surface, may have a flat, sloping surface, or may have a shape formed by a combination of these surfaces.

The processes described in the present Example are just examples, and the shape of the stage, the vacuum fixation method, and the like can be appropriately set as long as attachment can be performed while air is pushed out.

The flat main face of the pressure sensitive adhesive sheet 3 may be first attached to the image display unit 1, and then the peak 8 may be pressed against the protective plate 2.

FIGS. 6(a) to 6(c) are cross-sectional views illustrating a variation of the display device of Example 1 according to the present invention in the attachment process. The thickest portion (peak 8) of the pressure sensitive adhesive sheet 3 does not need to be in the center, and may be at an end of the pressure sensitive adhesive sheet 3. That is, the pressure sensitive adhesive sheet 3 may have the thickest portion at the end. In this case, for example, the following embodiment is preferable. First, as illustrated in FIG. 6(a), the protective plate 2 having the pressure sensitive adhesive sheet 3 attached thereto is fixed on the plate stage 5 and the plate stage 5 is tilted toward the end side with the thickest portion of the pressure sensitive adhesive sheet 3. Next, as illustrated in FIG. 6(b), the thickest portion of the pressure sensitive adhesive sheet 3 is brought into contact with the image display unit 1, with the plate stage 5 being kept in the tilted state. Thereafter, as illustrated in FIG. 6(c), the pressure sensitive adhesive sheet 3 is pressed against the image display unit 1 while the plate stage 5 is moved toward the opposite direction of the tilt until the plate stages 4 and 5 are parallel to each other, whereby the protective plate 2 having the pressure sensitive adhesive sheet 3 attached thereto is attached to the image display unit 1. This allows fairly good suppression of entry of air bubbles.

### Example 2

A display device (image display unit) of Example 2 had the same configuration as that in Example 1 except for having a reflective display electrode in at least a part of the effective display region.

In the thus-produced display device having a protective plate according to the present Example, the refractive index of the pressure sensitive adhesive sheet serving as a buffer layer was consistent with the reflective index of each of the glass substrate constituting an image display unit and the acrylic plate serving as a protective plate. Accordingly, there was no light reflection in the interfaces between the protective plate and the pressure sensitive adhesive sheet, and between the display surface of the image display unit and the pressure sensitive adhesive sheet, which led to high visibility even under strong daylight in the outdoors. Further, high contrast display was achieved even in reflective display in which display is provided by reflecting sunlight on the reflective display electrode (reflective electrode).

In the case that a reflective display electrode is used in a part of the effective display region and a transparent electrode is used in other parts, the display device can be a transflective liquid crystal display device. In the case that a reflective display electrode is used in the entire effective display region, the display device can be a reflective liquid crystal display device. In the present Example, the display device was of a transflective type which has a reflective display electrode and a transparent electrode in the effective display region.

### Example 3

A display device of Example 3 had the same configuration as that in Example 1 except for having, instead of a protective plate, a resistive-film touch panel with a resistive film formed on the glass substrate.

In the thus-produced display device having a touch panel of the present Example, the refractive index of the pressure sensitive adhesive sheet serving as a buffer layer was consistent with the refractive index of each of the glass substrate constituting an image display unit and the glass substrate constituting the touch panel. Accordingly, there was no light reflection in the interfaces between the protective plate and the pressure sensitive adhesive sheet, and between the display surface of the image display unit and the pressure sensitive adhesive sheet, which led to high visibility even under strong sunlight in the outdoors. Further, no display failure due to the pressure on the touch panel was generated.

The touch panel is not specifically limited to the resistive film touch panel, and may be any of various touch panels such as a capacitive-sensing one or an electromagnetic-induction one.

### Comparative Example 1

A display device of Comparative Example 1 had an ultraviolet-curing liquefied acrylic resin as a buffer layer material. The image display unit and the acrylic plate serving as a protective plate were the same as those in Example 1. The refractive index after curing of the acrylic resin was set to about 1.5.

A proper amount of the liquefied acrylic resin was dropped on the image display unit, and the image display unit was calmly attached to the protective plate under a vacuum. After the pressure was returned to the normal pressure, the resin overflowed from the edge of the image display unit and the protective plate was wiped off with a solvent or the like, and ultraviolet rays in a proper amount was radiated to the acrylic resin from the protective plate side so that the resin was cured.

### Comparative Example 2

A display device of Comparative Example 2 had the same configuration as that in Comparative Example 1 except for having a reflective display electrode in at least a part of the effective display region. The display device of Comparative Example 2 was also of a transflective type as in Example 2.

In the thus-produced display devices with a protective plate of Comparative Examples 1 and 2, the refractive index of the acrylic resin serving as a buffer layer was consistent with the refractive index of each of the glass substrate constituting the display device and the acrylic plate serving as a protective plate. Accordingly, there was no light reflection in the interfaces between the protective plate and the pressure sensitive adhesive sheet, and between the display surface of the image display unit and the pressure sensitive adhesive sheet, which led to high visibility even under strong sunlight in the outdoors.

However, some shocks applied to the protective plate caused display unevenness in the image display unit because of the defect in the cell gap. Also, some excessive shocks applied to the protective plate caused breakage of the image display unit.

The results comparing the performances of the display devices in Examples 1 to 3 and Comparative Examples 1 and 2 are described below. The measurements were performed with a luminance meter BM-5A (produced by TOPCON CORP.) in the lighting environments with an illumination of 0 luxes (lx) which was of a darkroom, and with an illumination of 20000 luxes (lx) which was an estimated value under a cloudy weather. Table 1 shows relationships between the luminance and contrast, which were measured in the respective lighting environments.

TABLE 1

| | 0 lx | | 20000 lx | |
|---|---|---|---|---|
| | Luminance | Contrast | Luminance | Contrast |
| Example 1 | 300 | 220 | 300 | 5 |
| Example 2 | 100 | 220 | 720 | 20 |
| Example 3 | 300 | 220 | 300 | 5 |
| Comparative | 280 | 220 | 280 | <1 |
| Example 1 | | | | |
| Comparative | 90 | 220 | 650 | 7 |
| Example 2 | | | | |

The transmissive display devices in Examples 1 and 3 had a higher luminance than that of the similar transmissive display device in Comparative Example 1, and also had a higher contrast under 20000 luxes. Also, the display device in Comparative Example 1 had a contrast of 1 or less under 20000 luxes, and display was almost invisible. The display device in Comparative Example 1 therefore was not suitable for a portable device. Further, the transflective display device in Example 2 had a higher luminance than that of the similar transflective display device in Comparative Example 2, and also had a higher contrast under 20000 luxes. Particularly the display device in Example 2 had a very high visibility under both 0 luxes and 20000 luxes, and therefore was considered as an optimum display device for a portable device.

The present application claims priority to Patent Application No. 2007-323703 filed in Japan on Dec. 14, 2007 under the Paris Convention and provisions of national law in a designated State, the entire contents of which are hereby incorporated by reference.

### BRIEF DESCRIPTION OF DRAWINGS

FIG. 1 are schematic views illustrating the display device of Example 1 according to the present invention: FIG. 1(a) is an exploded view from the cross section; and FIG. 1(b) is a plan view.

FIGS. 2(a) to 2(c) are cross-sectional views illustrating the display device of Example 1 according to the present invention in the attachment process.

FIG. 3 are schematic views illustrating a variation of the display device of Example 1 according to the present invention: FIG. 3(a) is a cross-sectional view; and FIG. 3(b) is a plan view.

FIG. 4 is a cross-sectional view schematically illustrating another variation of the display device of Example 1 according to the present invention.

FIG. 5 are schematic views illustrating a variation of the display device of Example 1 according to the present invention: FIG. 5(a) is an exploded view from the cross section; and FIG. 5(b) is a plan view.

FIGS. 6(a) to 6(c) are cross-sectional views illustrating a variation of the display device of Example 1 according to the present invention in the attachment process.

FIG. 7 are schematic views illustrating the display device of Example 1 according to the present invention: FIG. 7(a) is a cross-sectional view; and FIG. 7(b) is a plan view.

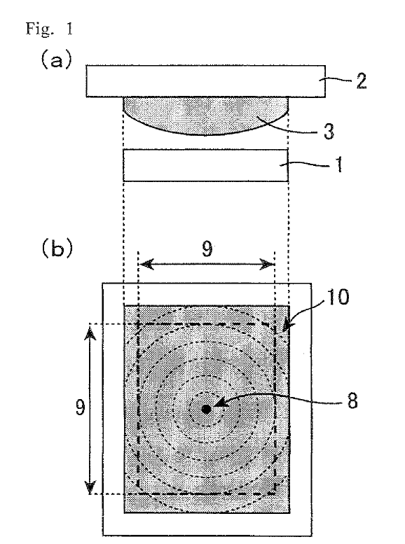

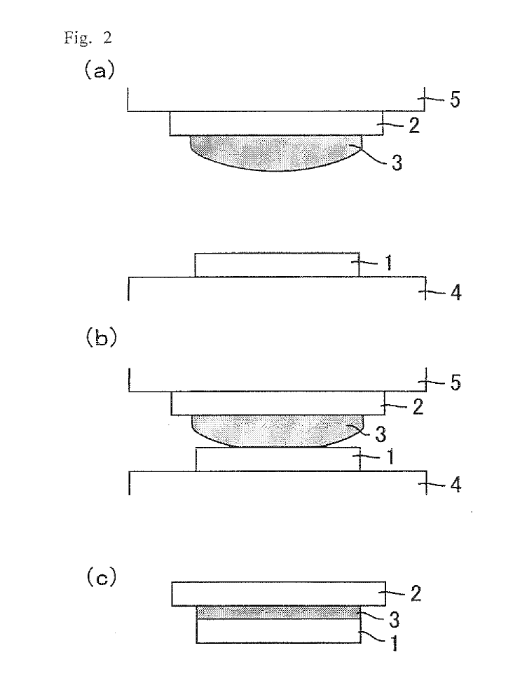

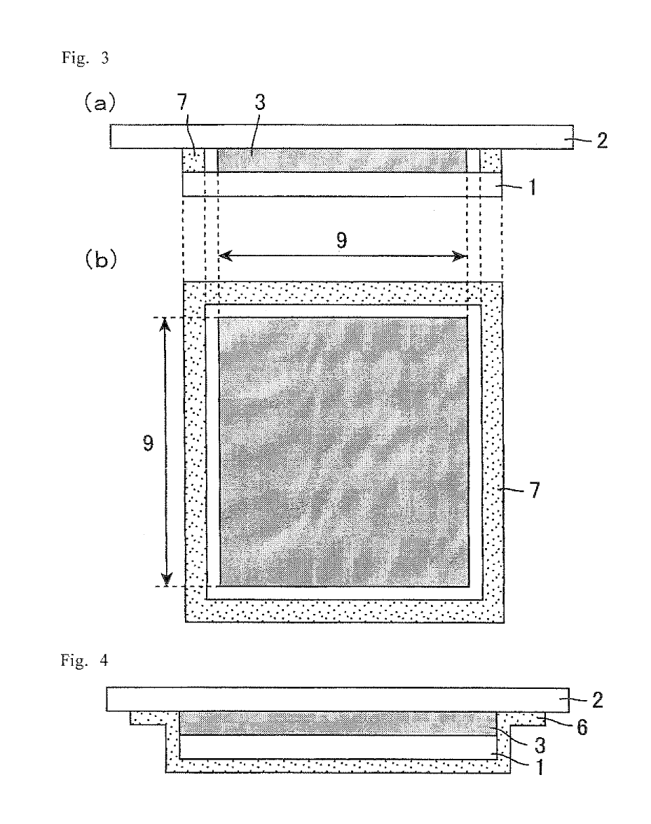

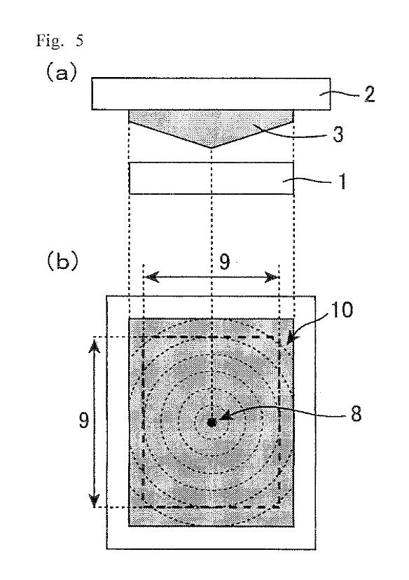

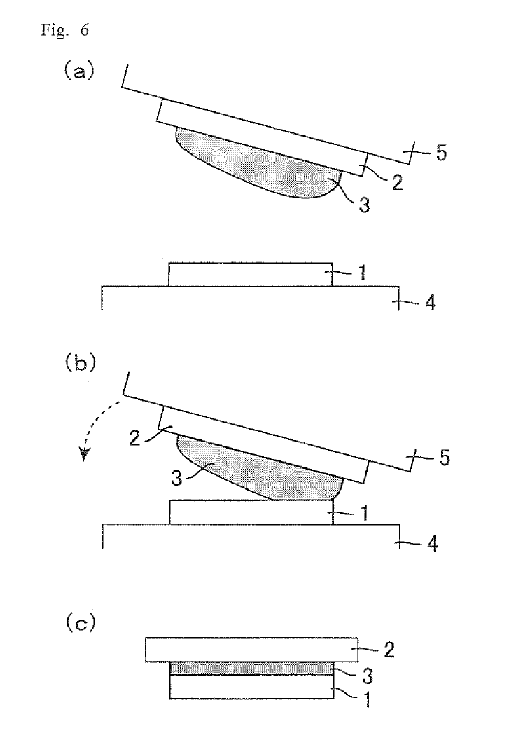

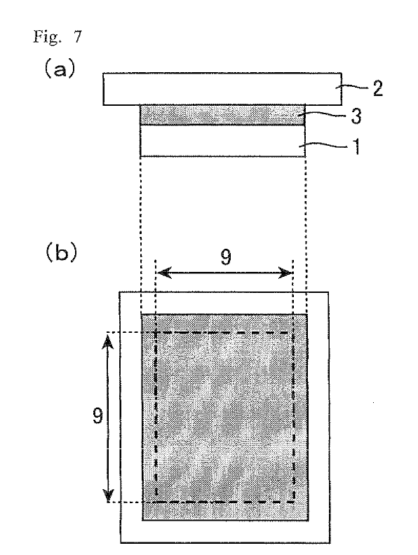

### EXPLANATION OF NUMERALS AND SYMBOLS

1: Image display unit
2: Protective plate
3: Pressure sensitive adhesive sheet
4, 5: Plate stage
6: Adhesive member
7: Pressure sensitive adhesive member
8: Peak (thickest portion)
9: Display region
10: Contour line

1. A pressure sensitive adhesive sheet for attaching an image display unit and a front plate,
wherein the pressure sensitive adhesive sheet has a thickest portion with a largest thickness within a region corresponding to a display region of the image display unit, and has a thickness which continuously decreases from the thickest portion toward the end of the region.

2. The pressure sensitive adhesive sheet according to claim 1, wherein the thickest portion is in the center of the region corresponding to the display region of the image display unit.

3. The pressure sensitive adhesive sheet according to claim 1, wherein the pressure sensitive adhesive sheet has a refractive index consistent with a refractive index of a member of each of the image display unit and the front plate, the member to be in contact with the pressure sensitive adhesive sheet.

4. The pressure sensitive adhesive sheet according to claim 1, wherein the pressure sensitive adhesive sheet contains silicone gel.

5. The pressure sensitive adhesive sheet according to claim 1, wherein the pressure sensitive adhesive sheet has one main face that is flat within the region corresponding to the display region of the image display unit.

6. A display device comprising the image display unit and the front plate that are attached via the pressure sensitive adhesive sheet according to claim 1.

7. The display device according to claim 6, wherein the front plate has a touch panel function.

8. The display device according to claim 6, further comprising an adhesive or pressure sensitive adhesive member different from the pressure sensitive adhesive sheet, the adhesive or pressure sensitive adhesive member cooperating with the pressure sensitive adhesive sheet to attach the image display unit and the front plate.

9. The display device according to claim 8, wherein the adhesive or pressure sensitive adhesive member is in a non-display region between the image display unit and the front plate.

10. The display device according to claim 6, wherein the image display unit is a liquid crystal display device.

11. The display device according to claim 10, wherein the liquid crystal display device has a reflective display electrode in at least a part of an effective display region.
